(19) United States
(12) Patent Application Publication
(10) Pub. No.: US 2024/0070476 A1
(43) Pub. Date: Feb. 29, 2024

(54) OPTIMAL CONSTRAINED MULTIWAY SPLIT CLASSIFICATION TREE

(71) Applicant: INTERNATIONAL BUSINESS MACHINES CORPORATION, Armonk, NY (US)

(72) Inventors: Shivaram Subramanian, Frisco, TX (US); Wei Sun, Scarsdale, NY (US); Markus Ettl, Yorktown Heights, NY (US)

(21) Appl. No.: 17/899,534

(22) Filed: Aug. 30, 2022

(51) Int. Cl. G06N 5/00; G06N 5/02

(52) U.S. Cl. CPC G06N 5/003; G06N 5/022

(57) ABSTRACT

A computer-implemented machine learning method includes accessing a decision tree associated with a path-based machine learning model. The decision tree is split into a plurality of multiway decision trees in a path-based formulation, each of the plurality of decision trees having an attribute not occurring more than once in each of the plurality of decision trees. A problem associated with the machine learning model is solved using one or more of the plurality of decision trees in which one or more decision rules of the decision tree are mapped using a mixed-integer program (MIPS).

### BACKGROUND

### Technical Field

The present disclosure generally relates to optimal decision tree learning, and more particularly, to the used of mixed integer programs (MIPS) in decision tree learning.

### Description of the Related Art

Decision trees are one of the more popular machine learning models because the tree structure is visually easy to comprehend. The learning of an optimal decision tree is Non-deterministic Polynomial-time hard (NP-hard). Popular algorithms rely on greedy heuristic-based methods that are challenging to incorporate constraints. MIP methods, which build on an arc-based formulation, are used to handle sample-level constraints and linear metrics.

### SUMMARY

In one embodiment, a computer-implemented decision tree machine learning method includes accessing a decision tree associated with a path-based machine learning model. The decision tree is split into a plurality of multiway decision trees, each of the plurality of decision trees having an attribute not occurring more than once in each of the plurality of decision trees. A problem associated with the machine learning model is solved using one or more of the plurality of decision trees in which one or more decision rules of the decision tree are mapped using a mixed-integer program (MIPS).

According to an embodiment, the decision tree in the splitting operation is a multiway decision tree.

According to an embodiment, solving the problem further associated with the path-based machine learning model includes finding multiway regression tress using mixed-integer programs (MIPS).

According to an embodiment, solving the problem includes incorporating rule constraints associated with solving the problem.

According to an embodiment, the incorporating constraints include an intra-rule and/or an inter-rule constraint.

According to an embodiment, the incorporating constraints include a monotonic prediction output and/or a fairness constraint.

According to an embodiment, solving the problem further comprises analyzing metrics including a precision and/or recall for imbalanced datasets.

According to an embodiment, solving the problem further includes performing column generation to provide a restricted master program version of the multiway decision trees.

According to an embodiment, solving the problem further includes generating a feature graph in which each decision rule is mapped to a distinct independent path in the feature graph.

According to an embodiment, generating the feature graph includes providing an acyclic multi-level digraph comprising multiple features, and each future indicates a level in the feature graph represented by multiple nodes corresponding to its distinct feature values.

In one embodiment, a computing device configured to perform decision tree machine learning includes a processor, and a memory coupled to the processor. The memory stores instructions to cause the processor to perform acts including accessing a decision tree associated with a path-based machine learning model; splitting the decision tree into a plurality of multiway decision trees, each of the plurality of decision trees having an attribute not occurring more than once in each of the plurality of decision trees; and solving a problem associated with the machine learning model using one or more of the plurality of decision trees in which one or more decision rules of the decision tree are mapped using a mixed-integer program (MIPS).

In one embodiment, a non-transitory computer readable storage medium tangibly embodying a computer readable program code having computer readable instructions that, when executed, causes a computer device to carry out a method of decision tree machine learning. The method includes accessing a decision tree associated with a path-based machine learning model. The decision tree is split into a plurality of decision trees, each of the plurality of decision trees having an attribute not occurring more than once in each of the plurality of decision trees. A problem associated with the machine learning model is solved using one or more of the plurality of decision trees in which one or more decision rules of the decision tree are mapped using a mixed-integer program (MIPS). The plurality of decision trees are multiway decision trees provided by the splitting operation, and solving the problem further includes performing column generation.

### BRIEF DESCRIPTION OF THE DRAWINGS

The drawings are of illustrative embodiments. They do not illustrate all embodiments. Other embodiments may be used in addition to or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1A illustrates optimal multiway-split trees (OMTs) having particular feature values mapped to a node, consistent with an illustrative embodiment.

FIG. 1B illustrates OMTs in which cumulative binning is applied to ordinal features, consistent with an illustrative embodiment.

FIG. 2 illustrates a path-based method to construct an optimal constrained classification tree with multiway splits, consistent with an illustrative embodiment.

FIG. 3 illustrates a multi-way split classification tree consistent with an illustrative embodiment.

FIG. 4 illustrates is a flowchart illustrating a computer-implemented method of decision tree machine learning, consistent with an illustrative embodiment.

FIG. 5 is a functional block diagram illustration of a computer hardware platform, consistent with an illustrative embodiment.

FIG. 6 depicts an illustrative cloud computing environment, consistent with an illustrative embodiment.

FIG. 7 depicts a set of functional abstraction layers provided by a cloud computing environment, consistent with an illustrative embodiment.

### DETAILED DESCRIPTION

### Overview

In the following detailed description, numerous specific details are set forth by way of examples to provide a thorough understanding of the relevant teachings. However, it is to be understood that the present teachings may be practiced without such details. In other instances, well-known methods, procedures, components, and/or circuitry have been described at a relatively high level, without detail, to avoid unnecessarily obscuring aspects of the present teachings. It is also to be understood that the present disclosure is not limited to the depictions in the drawings, as there may be fewer elements or more elements than shown and described.

In discussing the present technology, it may be helpful to describe various salient terms. In one aspect, spatially related terminology such as “front,” “back,” “top,” “bottom,” “beneath,” “below,” “lower,” above,” “upper,” “side,” “left,” “right,” and the like, is used with reference to the direction of the Figures being described. Since components of embodiments of the disclosure can be positioned in a number of different directions, the directional terminology is used for purposes of illustration and is in no way limiting. Thus, it will be understood that the spatially relative terminology is intended to encompass different directions of the device in use or operation in addition to the direction depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other directions) and the spatially relative descriptors used herein should be interpreted accordingly.

Although the terms first, second, third, etc., may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

Example embodiments are described herein with reference to schematic illustrations of idealized or simplified embodiments (and intermediate structures). As such, variations from the shapes of the illustrations as a result, for example, of manufacturing techniques and/or tolerances, may be expected. Thus, the regions illustrated in the figures are schematic in nature and their shapes do not necessarily illustrate the actual shape of a region of a device and do not limit the scope.

It is to be understood that other embodiments may be used and structural or logical changes may be made without departing from the spirit and scope defined by the claims. The description of the embodiments is not limiting. In particular, elements of the embodiments described hereinafter may be combined with elements of different embodiments.

As used herein, the term “multiway” tree when referring to decision trees and/or split trees is to be understood as being able to have more than two children.

The present disclosure provides a novel method of learning optical decision trees using mixed-integer programs (MIPS) in a path-based formulation. Typically, MIP methods are built on an arc-based formulation and do not scale well because the number of binary variables and constraints are on the order of O (2^{d}N), where d and N refer to the depth of the tree and the size of the dataset. Moreover, such MIP methods built on an arc-based formulation can only handle sample-level constraints and linear metrics. In contrast, in one aspect, the present disclosure teaches a path-based MIP formulation where the number of decision variables is independent of both d and N.

More particularly, the present disclosure presents a scalable column generation framework to provide solutions to the decision tree problems by providing an optimal multiway-split tree (OMT) which is more interpretable and informative than typical binary-split trees due to shorter rules. For example, the framework is more general and can handle nonlinear metrics and incorporate a broader class of constraints during training.

Through the use of multiway-split trees, an attribute rarely appears more than once in any path from root to leaf, which are easier to comprehend than its binary counterparts. In the path-based formulation, each feasible rule is mapped to a distinct path in a graph. As the cardinality of paths become prohibitive for larger graphs with many numerical features, the path-based MIP formulation address this issue using an enhanced column generation technique.

The embodiments of the computer-implemented method and computing device of the present disclosure provide for an improvement in the field of providing solutions to the decision tree problems in a variety of different applications, as more accurate decisions can be made based on analyzing the predicted model while taking into consideration constraints and interdependencies. In addition, there is an improvement in computer operations, as the computer-implemented method and system according to the present disclosure reduces the amount of processing power used to achieve results with reduced storage usage, and the results have increased accuracy. Results of extensive experiments on datasets demonstrate the efficiency and superiority over existing MIP-based decision tree models. In one embodiment, there is a 24× reduction in run time.

In one aspect, the teachings herein are based on the inventors' insight that the techniques described herein may be implemented in a number of ways. Example implementations are provided below with reference to the following figures.

### Example Architecture

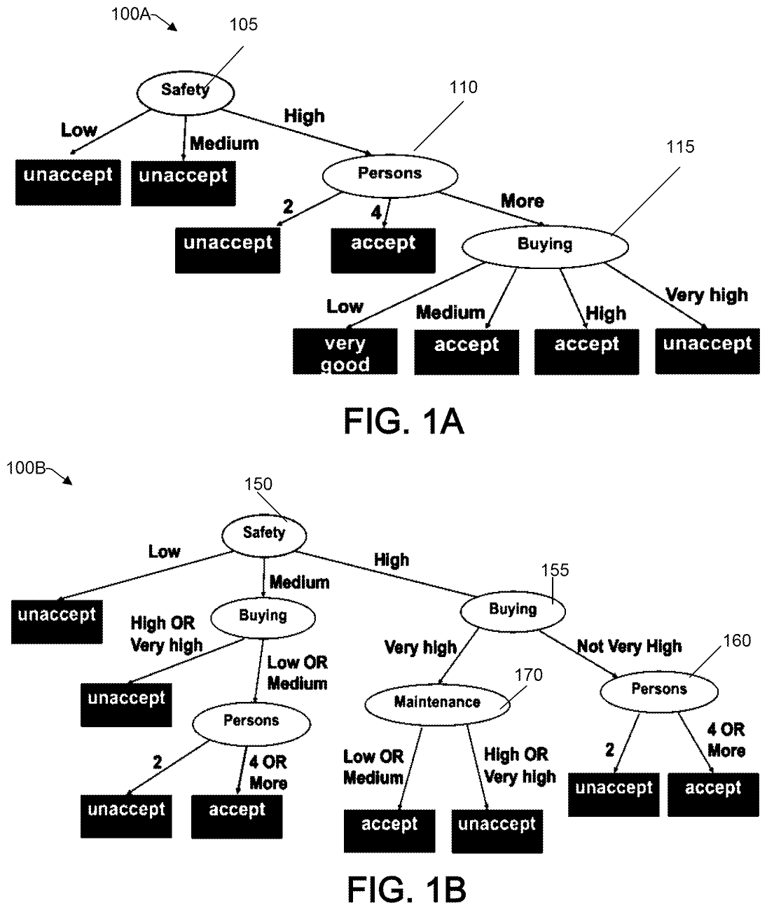

FIG. 1A illustrates optimal multiway-split trees (OMTs) 100A trained on car evaluation, consistent with an illustrative embodiment. The particular feature values are mapped to a node. As shown in FIG. 1A, each unique feature is mapped to a node. For example, safety 105 may have low, medium, and high conditions. Those are three conditions, which is more accurate, and more efficient than having binary trees in which each feature (such as of safety 105) is present with binary classification, for example, low or not, medium or not, high or not. The Persons node 110 has three branching conditions, and the buying node 115 has four branching conditions. There are 8 leaf nodes (l=8) and the depth is 3.

FIG. 1B illustrates OMTs 100B in which cumulative binning is applied to ordinal features, consistent with an illustrative embodiment. Binning is used to reduce the number of levels of a node. The arrangement of the safety 150, buying 155, persons 160, and maintenance 170 is binned to provide a more efficient way classify the plurality of ordinal features, e.g., where the levels associated with the feature represent increasing or decreasing value such as ‘low’, ‘medium’, ‘high’. Cumulative binning enables a decision rule to include combinatorial conditions. In addition, in a case where the consideration of a numerical features with values (e.g., [0, 1]) may be divided into a plurality of intervals. In the case of 3 values, there can be intervals such as [0, 0.33), (0.33, 0.67), (0.67, 1.0)]. The tree shown in FIG. 1B has a higher in-sample accuracy than in FIG. 1S.

### Example Embodiments

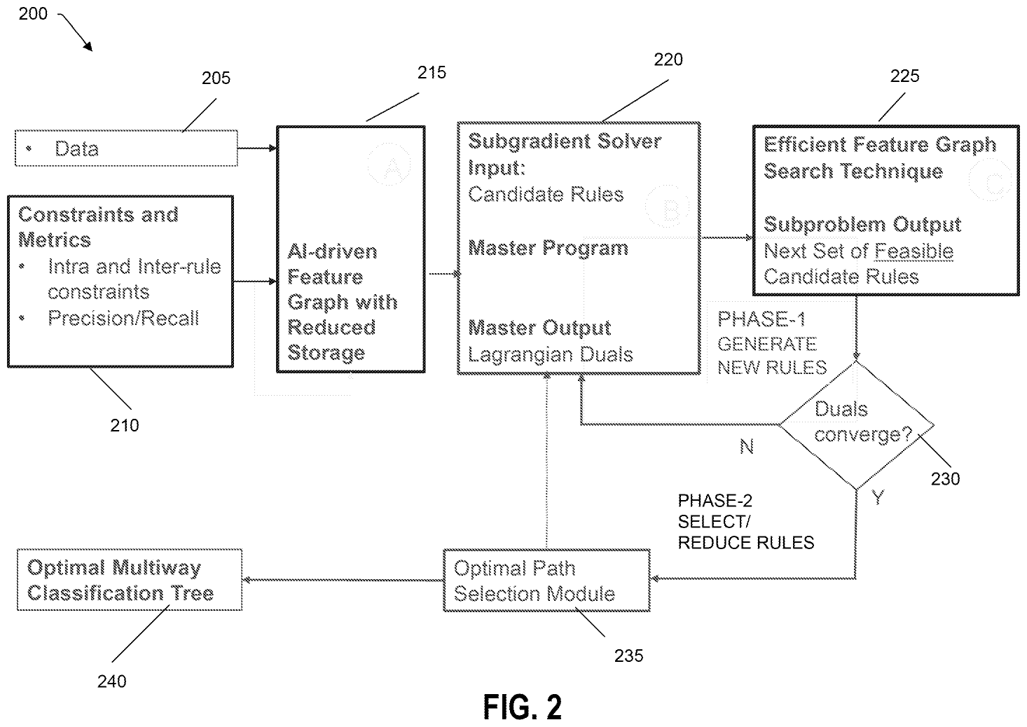

FIG. 2 illustrates a path-based method 200 to construct an optimal constrained classification tree with multiway splits, consistent with an illustrative embodiment. The path-based MIP approach of constructing optimal classification trees is scalable and flexible to incorporate constraints and any accuracy metric. According to the illustrative embodiment, the method produces multiway-split trees, instead of using binary split trees. An attribute rarely appears more than once in any path from root to leaf, which is easier to comprehend than its binary counterparts.

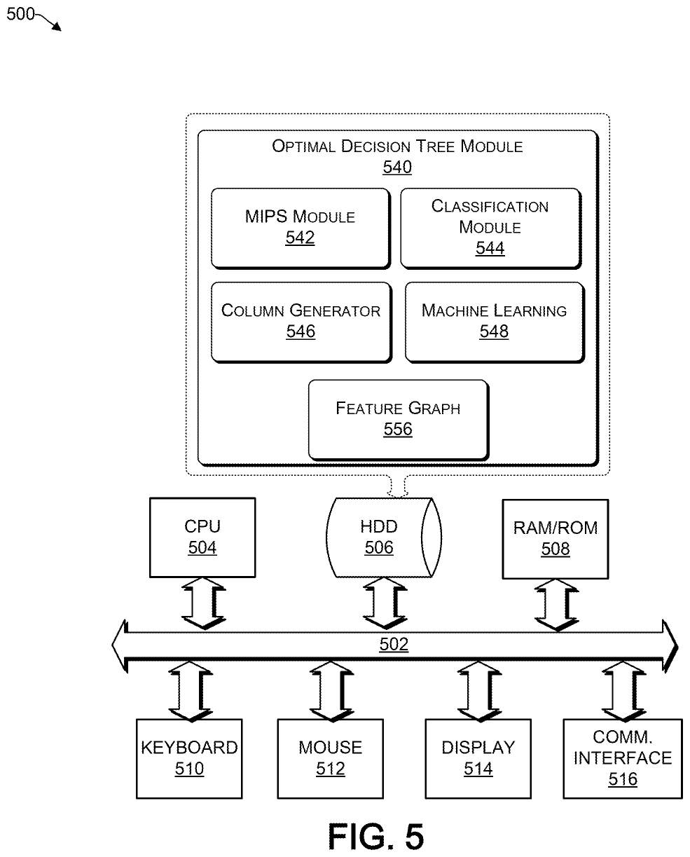

In our path-based MIP formulation, each feasible rule is mapped to a distinct path in a graph. As the cardinality of paths becomes prohibitive for large graphs (e.g., many numerical features), the method addresses this issue by using an enhanced column generation technique. This formulation allows us to incorporate constraints, e.g., monotonic predicted output, fairness constraint, precision and/or a recall for imbalanced datasets, etc. Data 205 along with constraints and metrics 210 are provided to construct a feature graph 215. The data 205 may include transaction in the training data, such as a list of features sored in order of importance suggested by any black box prediction model. In an embodiment, a decision tree module 540 (FIG. 5) is one non-limiting illustration of the modules in a computing device performing the computer-implemented method. The number of modules is not limited to what is shown.

With continued reference to FIG. 2, the feature graph embeds the hierarchical structure of a tree, and constraints are added to model a property of decision trees. For example, each sample may be assigned to a single rule. For a given feature f a node may be created for each distinct feature value. The feature graph may admit every valid combination of input features as a feasible decision rule candidates. As shown in FIG. 2, operations 220, 225 and 230 may be considered “phase 1” associated with rule generation. Operations 235 and 240 may be considered “phase 2” associated with selecting and/or reducing decision candidate rules. In the case of an acyclic multi-level digraph, where each feature indicates a level in the graph represented by multiple nodes corresponding to its distinct features. Nodes of one feature are fully connected to nodes in the next level. The feature graph also includes a source and a sink. A decision rule is defined as a path from the source to the sink. At 220, the feature graph information is provided to a subgradient solver input 220 that includes candidate rules, a master program, a master output and Lagrangian Duals.

With reference to the subgradient solver input 220, a Lagrangian Relaxation (LR) is construct of a CL Tree Master Program includes dualizing cover, capacity, and cardinality constraints by incorporating within the objective via Lagrange multipliers (E). The LR decomposes into simple bound-constrained problems separable by market and rule. To solve LR, compute the resultant objective Lₖ. Record the best (maximum) value L* so far, compute capacity constraint violations (negative subgradients), compute the resultant capacity violation error vector dₖ, compute deflected subgradient gₖ₊₁=αdₖ+(1−α)gₖ, where α is an algorithmic parameter. Optionally, there may be obtained primal estimates s*ₖ₊₁=αsₖ+(1−α)s*ₖ, updating the dual vector E, E^{k+1}=E^{k}+2α(θ−L*)g/∥g∥², where θ is a carefully chosen target value. Finally E^{k+1} is projected onto its bounds to preserve dual feasibility. Stop when g is small, or a time limit expires, and return E^{k} as the best shadow price estimate.

At 225, an efficient feature graph search technique is performed, and an output of a next set of feasible candidates rules. Enhancements to this technique reduce storage requirements and computation time. These enhancements include: (i) creating only symbolic representations of cumulative nodes. This reduces storage to the original O(κ) by sorting the feature nodes (done only once at the start of the CG algorithm) with individual (x) nodes first followed by cumulative nodes. The intersections of a partial path's training samples are performed with the samples of the individual nodes first. (ii) Computing set intersections is reduced to linear time O(m), which is done by always operating on pre-sorted training sample data in the partial path and nodes. (iii) Apply the distributive law of set intersections. Compute of expensive intersections is reduced to O(κ)×O(κ). This allows us to compute the intersections for cumulative nodes performing unions of intersections of individual sets and the prior level of accumulation, e.g., union of no more than two sets of training samples. Discretization quality is improved by initializing the κ-means algorithm using quantiles. For example, the data are sorted and partitioned into κ equal intervals, and the mean value of each interval is used to generate the starting points for the κ-means procedure

At 230 the decision tree module (e.g., FIG. 5, decision tree module 540) determines whether the dual variable values converge. An affirmative decision at operation 230 is provided to an optimal path selection module 235. An optimal multiway classification tree is then formed or updated at 240. For example, If there is no initial classification tree, then such a tree is formed here for the first time. Optionally, the entire CG procedure (200-235) may be run more than once. If an improved solution is obtained at operation 235, then the tree obtained in the previous run can be replaced by the new solution at operation 240. A classification module 544 (such as shown in FIG. 5) may be used to perform the aforementioned operations under control of a decision tree module 540.

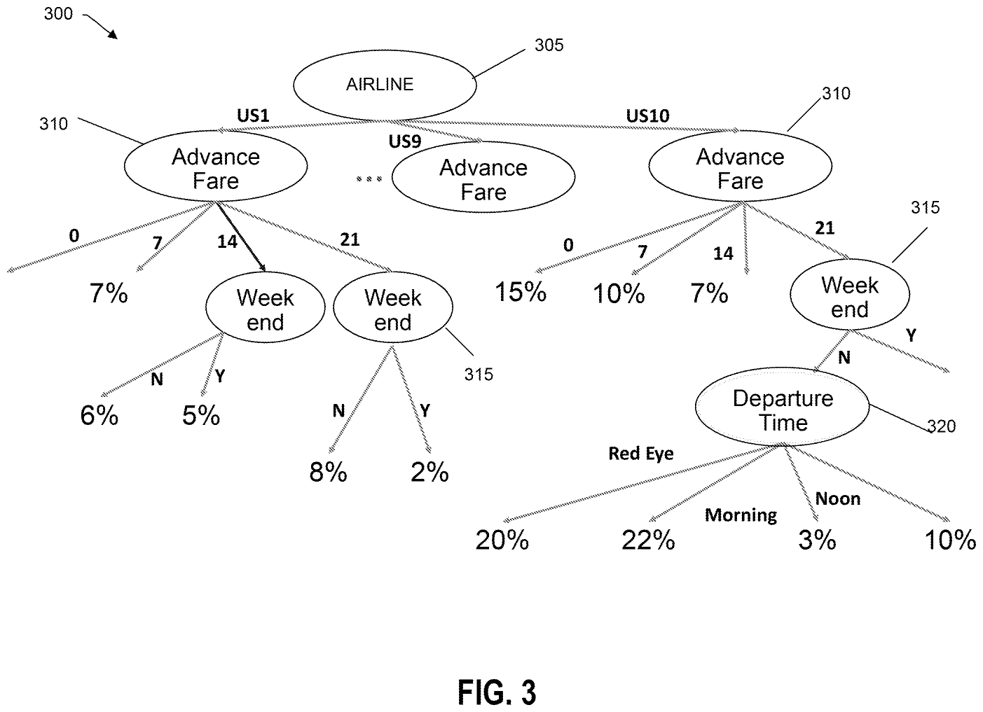

FIG. 3 illustrates a multi-way split classification tree consistent with an illustrative embodiment. While in this example, an airline upsell propensity is used, it is to be understood that the method is not limited to any particular subject matter such as that associated with airline operations. The airline 305 has advance fare nodes 310 with factors such as same day (0), one week (7), two weeks (14), and three weeks (21). The weekend 315, departure time 320 are all variables that are used to structure the multiway tree. By virtue of the architecture of the multiway trees, the processing time to map the rules to distinct paths is improved, and there is a power reduction in performing the classification operations.

### Example Process

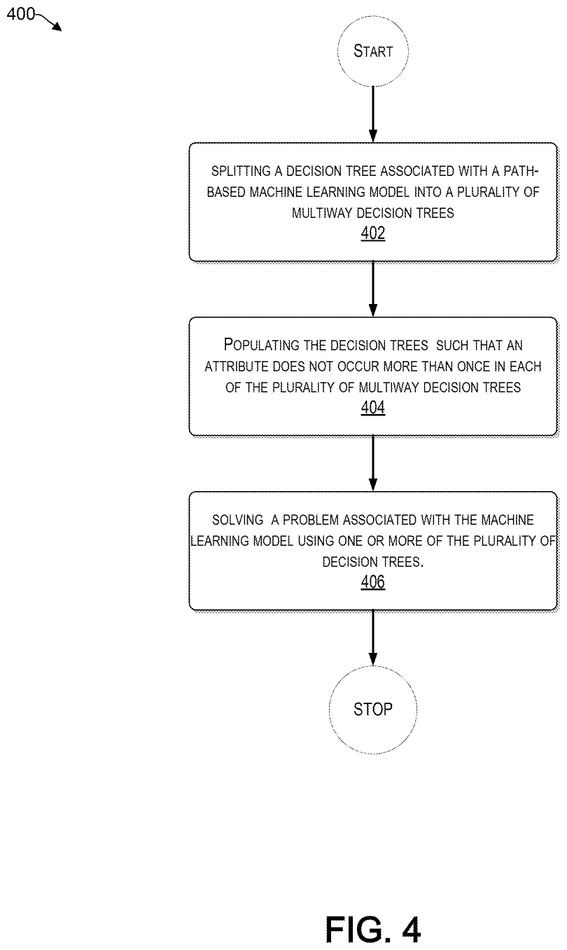

With the foregoing overview of the example architecture, it may be helpful now to consider a high-level discussion of an example process. To that end, FIG. 4 is a flowchart illustrating a computer-implemented method of decision tree machine learning, consistent with an illustrative embodiment.

FIG. 4 is shown as a collection of blocks, in a logical order, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At operation 402, a decision tree associated with a path-based machine learning model is split by a decision tree module (See FIG. 5, decision tree module 540) into a plurality of multiway decision trees in a path-based formulation. The splitting into multiway decision trees have more than two nodes, which is more efficient and accurate than binary level decision trees.

At operation 404, the decision trees are populated such that an attribute does not occur more than once in each of the plurality of multiway decision trees for most attributes. By mapping each feature to a node, it is more efficient than an arc-based operation.

At operation 406, a computing device having modules such as illustrated in FIG. 5 solves a problem associated with the machine learning model (e.g. FIG. 5, machine learning model 548) using one or more of the plurality of decision trees. The solution may be obtained by performing one or more of: a column generation (CG) operation (e.g., performed by a column generator module 546 shown in FIG. 5) and providing a restricted master program version of the multiway decision trees, finding multiway regression tress using mixed-integer programs (MIPS), incorporating constraints in solving the problem including intra-rule and inter-rule constraints, and/or incorporating a monotonic prediction output and/or a fairness constraint. The method then ends at 406.

### Example Particularly Configured Computer Hardware Platform

FIG. 5 provides a functional block diagram illustration 500 of a computer hardware platform, consistent with an illustrative embodiment. In particular, FIG. 5 illustrates a particularly configured network or host computer platform 500, as may be used to implement the method shown in FIG. 4.

The computer platform 500 may include a central processing unit (CPU) 504, a hard disk drive (HDD) 506, random access memory (RAM) and/or read-only memory (ROM) 508, a keyboard 510, a mouse 512, a display 514, and a communication interface 516, which are connected to a system bus 502. The HDD 506 can include data stores.

In one embodiment, the HDD 506 has capabilities that include storing a program that can execute various processes, such as machine learning, predictive modeling, classification, updating model parameters. The ML model generation module 540 is configured to generate a machine learning model based on at least one of the generated candidate machine learning pipelines.

With continued reference to FIG. 5, there are various modules shown as discrete components for ease of explanation. However, it is to be understood that the functionality of such modules and the quantity of the modules may be fewer or greater than shown. An optimal decision tree module 540 is configured to generate multiway decision trees that are more interpretable and informative than binary-split trees due to shorter rules. An MIPs module 542 is configured to operation on a path-based formulation MIP formulation in which there are explicitly modeled decision rules or paths in a tree to identify a constrained subset of rules to minimize the prediction error. A classification module 544 is used in an illustrative embodiment to provide discrete labels for classification and regression settings. A column generator module 546 is configured to solve problems efficiently when it is not practical to explicitly generate all the columns (variables) of the problem matrix. For example, the column generator module 546 may be configured to provide a restricted master program (RMP) of optimal multiway split decision trees. The multiway-split tree includes a node which has includes two or more children nodes.

A machine learning module 548 is configured to assist in generating multiway decision trees from path-based formulations that are more interpretable and informative than binary-split trees. A feature graph module 556 is configured to generate a multi-level diagraph, where each features indicates a level in the graph represented by multiple nodes corresponding to its distinct feature values.

### Example Cloud Platform

As discussed above, functions relating prescriptive may include a cloud. It is to be understood that although this disclosure includes a detailed description of cloud computing as discussed herein below, the implementation of the teachings recited herein is not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

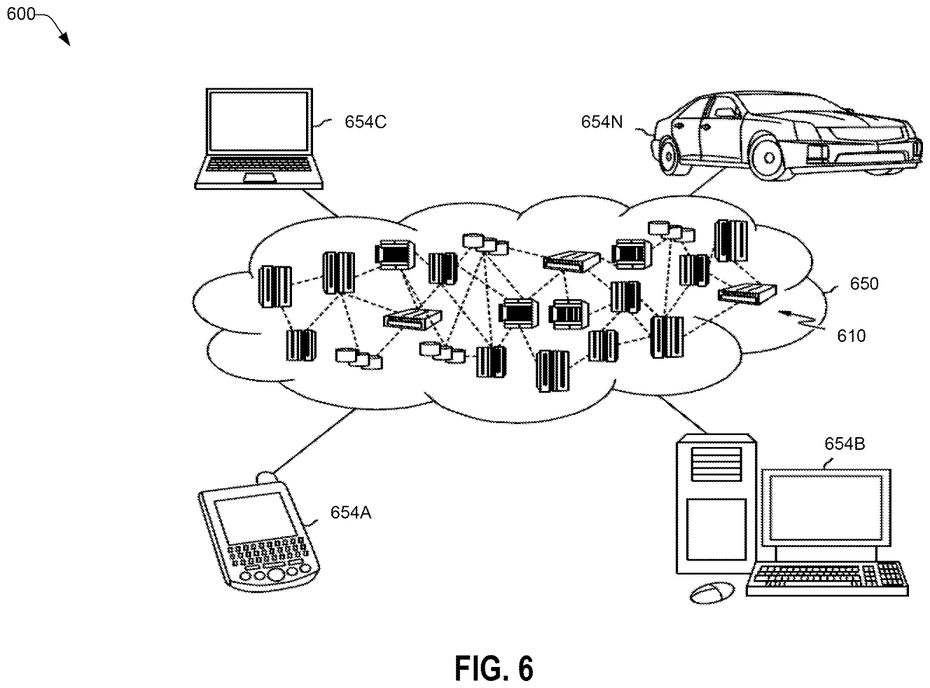

FIG. 6 depicts an illustrative cloud computing environment, consistent with an illustrative embodiment. As shown, cloud computing environment 600 includes cloud 650 having one or more cloud computing nodes 610 with which local computing devices used by cloud consumers, such as, for example, personal digital assistant (PDA) or cellular telephone 854A, desktop computer 654B, laptop computer 654C, and/or automobile computer system 654N may communicate. Nodes 610 may communicate with one another. They may be grouped (not shown) physically or virtually, in one or more networks, such as Private, Community, Public, or Hybrid clouds as described hereinabove, or a combination thereof. This allows cloud computing environment 600 to offer infrastructure, platforms, and/or software as services for which a cloud consumer does not need to maintain resources on a local computing device. It is understood that the types of computing devices 654A-N shown in FIG. 6 are intended to be illustrative only and that computing nodes 610 and cloud computing environment 600 can communicate with any type of computerized device over any type of network and/or network addressable connection (e.g., using a web browser).

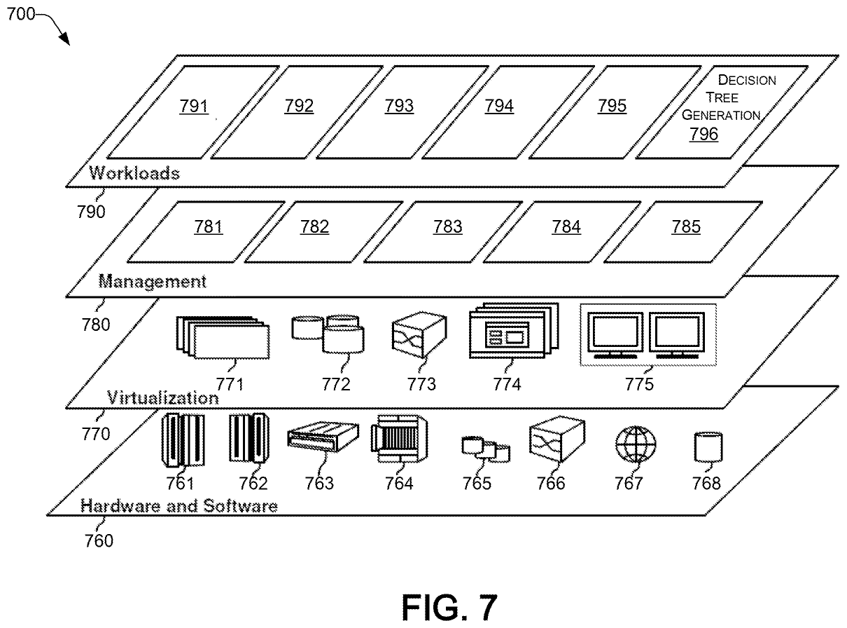

Referring now to FIG. 7, a set of functional abstraction layers 700 provided by cloud computing environment 600 (FIG. 6) is shown. It should be understood in advance that the components, layers, and functions shown in FIG. 7 are intended to be illustrative only and embodiments of the disclosure are not limited thereto. As depicted, the following layers and corresponding functions are provided:

Hardware and software layer 760 include hardware and software components. Examples of hardware components include: mainframes 761; RISC (Reduced Instruction Set Computer) architecture-based servers 762; servers 763; blade servers 764; storage devices 765; and networks and networking components 766. In some embodiments, software components include network application server software 767 and database software 768.

Virtualization layer 770 provides an abstraction layer from which the following examples of virtual entities may be provided: virtual servers 771; virtual storage 772; virtual networks 773, including virtual private networks; virtual applications and operating systems 774; and virtual clients 775.

In one example, management layer 780 may provide the functions described below. Resource provisioning 781 provides dynamic procurement of computing resources and other resources that are utilized to perform tasks within the cloud computing environment. Metering and Pricing 782 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 783 provides access to the cloud computing environment for consumers and system administrators. Service level management 784 provides cloud computing resource allocation and management such that required service levels are met. Service Level Agreement (SLA) planning and fulfillment 785 provide pre-arrangement for, and procurement of, cloud computing resources for which a future requirement is anticipated in accordance with an SLA.

Workloads layer 790 provides examples of functionality for which the cloud computing environment may be utilized. Examples of workloads and functions which may be provided from this layer include: mapping and navigation 791; software development and lifecycle management 792; virtual classroom education delivery 793; data analytics processing 794; transaction processing 795; and an optimal decision tree generation module 796 configured to generate multiway decision trees that are more interpretable and informative than binary-split trees due to shorter rules, as discussed herein above.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, operations, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any such actual relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method of decision tree machine learning, the method comprising:
splitting a decision tree associated with a path-based machine learning model into a plurality of multiway decision trees in a path-based formulation, each of the plurality of decision trees having an attribute not occurring more than once in each of the plurality of decision trees; and
solving a problem associated with the path-based machine learning model using one or more of the plurality of decision trees in which one or more decision rules of the decision tree are mapped using a mixed-integer program (MIPS).

2. The computer-implemented method according to claim 1, wherein the decision tree in the splitting operation comprises a multiway decision tree.

3. The computer-implemented method according to claim 1, wherein solving the problem associated with the machine learning model further includes performing a column generation (CG) operation and providing a restricted master program version of the multiway decision trees.

4. The computer-implemented method according to claim 3, wherein solving the problem associated with the path-based machine learning model includes finding multiway regression tress using MIPS.

5. The computer-implemented method according to claim 1, wherein solving the problem comprises incorporating rule constraints associated with solving the problem.

6. The computer-implemented method according to claim 5, wherein the incorporating constraints in solving the problem comprises intra-rule and inter-rule constraints.

7. The computer-implemented method according to claim 5, wherein the incorporating constraints in solving the problem comprises incorporating a monotonic prediction output and/or a fairness constraint.

8. The computer-implemented method according to claim 1, wherein solving the problem associated with the machine learning model further comprises analyzing metrics including a precision and/or a recall for imbalanced datasets.

9. The computer-implemented method according to claim 1, wherein solving the problem further comprises generating a feature graph in which each decision rule is mapped to a distinct independent path in the feature graph.

10. The computer-implemented method according to claim 9, wherein:
the generating of the feature graph further includes providing an acyclic multi-level digraph comprising multiple features; and
each future indicates a level in the feature graph represented by multiple nodes corresponding to its distinct feature values.

11. A computing device configured to perform decision tree machine learning, the device comprising:
a processor;
a memory coupled to the processor, the memory storing instructions to cause the processor to perform acts comprising:
accessing a decision tree associated with a path-based machine learning model;
splitting the decision tree into a plurality of multiway decision trees in a path-based formulation, each of the plurality of decision trees having an attribute not occurring more than once in each of the plurality of decision trees; and
solving a problem associated with the machine learning model using one or more of the plurality of decision trees in which one or more decision rules of the decision tree are mapped using a mixed-integer program (MIPS).

12. The computing device according to claim 11, wherein the instructions cause the processor to perform an additional act comprising splitting of the decision tree into a plurality of multiway decision trees.

13. The computing device according to claim 11, wherein solving the problem associated with the machine learning model includes finding multiway regression tress using MIPS.

14. The computing device according to claim 11, wherein solving the problem comprises performing a column generation (CG) operation to operate a restricted master program version of the multiway decision trees.

15. The computing device according to claim 11, wherein the instructions cause the processor to perform an additional act comprising incorporating intra-rule and/or inter-rule constraints in solving the problem.

16. The computing device according to claim 11, wherein the instructions cause the processor to perform an additional act comprising incorporating a monotonic prediction output and/or a fairness constraint in solving the problem.

17. The computing device according to claim 11, wherein solving the problem comprises incorporating analyzing metrics including a precision and/or a recall for imbalanced datasets.

18. The computing device according to claim 11, wherein the instructions cause the processor to perform an additional act in solving the problem, comprising generating a feature graph in which each decision rule is mapped to a distinct independent path in the feature graph.

19. The computing device according to claim 18, wherein:
the instructions cause the processor to perform an additional act in the generating of the feature graph comprising providing an acyclic multi-level digraph including multiple features; and
each future indicates a level in the feature graph represented by multiple nodes corresponding to its distinct feature values.

20. A non-transitory computer readable storage medium tangibly embodying a computer readable program code having computer readable instructions that, when executed, causes a computer device to carry out a method of decision tree machine learning, the method comprising:
accessing a decision tree associated with a path-based machine learning model;
splitting the decision tree into a plurality of decision trees in a path-based formulation, each of the plurality of decision trees having an attribute not occurring more than once in each of the plurality of decision trees; and
solving a problem associated with the machine learning model using one or more of the plurality of decision trees in which one or more decision rules of the decision tree are mapped using a mixed-integer program (MIPS), wherein the plurality of decision trees comprises multiway decision trees provided by the splitting operation, and wherein solving the problem further includes performing column generation and providing a restricted master program version of the multiway decision trees.
